(19) United States
(12) Patent Application Publication
(10) Pub. No.: US 2014/0164460 A1
(43) Pub. Date: Jun. 12, 2014

(54) DIGITAL SIGNAL PROCESSING APPARATUS AND PROCESSING METHOD THEREOF

(71) Applicant: NUVOTON TECHNOLOGY CORPORATION, Hsinchu (TW)

(72) Inventor: Tsung-Hsien Hsieh, Hsinchu (TW)

(73) Assignee: NUVOTON TECHNOLOGY CORPORATION, Hsinchu (TW)

(21) Appl. No.: 13/776,724

(22) Filed: Feb. 26, 2013

(30) Foreign Application Priority Data
Dec. 7, 2012 (TW) 101146111

(51) Int. Cl. G06F 17/14

(52) U.S. Cl. CPC G06F 17/14
USPC 708/403

(57) ABSTRACT

A digital signal processing apparatus and a digital signal processing method are provided. The digital signal processing apparatus includes a memory, a control logic unit, a butterfly arithmetic unit, a selector, a first twiddle factor generator, a second twiddle factor generator and a twiddle factor latch. The first twiddle factor generator and the second twiddle factor respectively provide a first sub-twiddle factor and a second sub-twiddle factor. A weight value (twiddle factor) is produced by the butterfly arithmetic unit through performing a complex multiplication operation on the first sub-twiddle factor and the second sub-twiddle factor.

### CROSS-REFERENCE TO RELATED APPLICATION

This application claims the priority benefit of Taiwan application serial no. 101146111, filed on Dec. 7, 2012. The entirety of the above-mentioned patent application is hereby incorporated by reference herein and made a part of this specification.

### BACKGROUND OF THE INVENTION

1. Field of the Invention

The embodiment of the disclosure generally relates to the signal processing technology, and more particularly, to a digital signal processing apparatus and a processing method thereof.

2. Description of Related Art

Due to the prevalence of digital storage or computer process technology, the general signal processing often uses fast Fourier transform (FFT) to obtain a frequency spectrum corresponding to a signal, while discrete Fourier transform (DFT) provides a discrete approximation means for a continuous Fourier transform and it becomes very useful in many fields. The DFT algorithm-based FFT gains quite broad applications, such as radar, wireless communications, medical imaging, spectral analysis and acoustic application.

### SUMMARY OF THE INVENTION

An embodiment of the disclosure provides a digital signal processing apparatus, which includes a memory, a control logic unit, a butterfly arithmetic unit, a selector, a first twiddle factor generator, a second twiddle factor generator and a twiddle factor latch. The memory has a data output terminal, a data input terminal and a data address terminal. The control logic unit is electrically connected to the data address terminal. The butterfly arithmetic unit is electrically connected to the data output terminal, the data input terminal and the control logic unit. The selector is electrically connected to the butterfly arithmetic unit and the control logic unit. The first twiddle factor generator and the second twiddle factor generator respectively provide a first sub-twiddle factor and a second sub-twiddle factor. The twiddle factor latch is electrically connected to the control logic unit and the butterfly arithmetic unit, in which the twiddle factor latch is for latching a weight value of the first sub-twiddle factor and the second sub-twiddle factor after a complex multiplication operation performed by the butterfly arithmetic unit.

Another embodiment of the disclosure provides a digital signal processing method, which includes: providing a memory for storing N-points data; providing a first sub-twiddle factor and a second sub-twiddle factor; performing a complex multiplication operation on the first sub-twiddle factor and a second sub-twiddle factor by a complex multiplier of a butterfly arithmetic unit so as to produce a weight value; applying the weight value to FFT with N-points data so as to produce a plurality of transposed values; and writing back the transposed values to the memory.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an FFT's butterfly operation.

FIG. 2 is a signal processing flowchart illustrating a 16-points FFT.

FIG. 3 is a diagram showing a general architecture of a single processing unit.

FIG. 4 is a general architecture diagram showing a butterfly operation-based digital signal processing apparatus.

FIG. 5 is a schematic diagram of a digital signal processing apparatus according to an embodiment of the disclosure.

FIG. 6 is a flowchart showing a signal processing method according to an embodiment of the disclosure.

### DESCRIPTION OF THE EMBODIMENTS

FFT is a DFT-based digital signal processing algorithm and can largely save computing amount. An input vector x with N-points data after being performed with a

DFT becomes an output vector X with N-points data, in which the DFT can be expressed by formula 1 as follows:

$$\begin{matrix}X ( k ) = {\sum }_{n = 0}^{N - 1} x ( n ) * {e}^{\frac{- j 2 π kn}{N}} \\ = {\sum }_{n = 0}^{N - 1} x ( n ) * {W}_{N}^{kn} ,\end{matrix} \\ k = 0 , 1 , 2 , … , ( N - 1 ) , \qquad ( 1 )$$

wherein factor

$${W}_{N}^{kn} = {e}^{\frac{- j 2 π kn}{N}}$$

is referred as twiddle factor.

If the DFT of these N-points is directly computed according to the above-mentioned formula 1, the required number of operations of the direct algorithm is approximately N² times of complex multiplications and N*(N−1) times complex additions. Apparently, it is a very inefficient and impractical method. It is clear that if no optimization to be followed, DFT is unable to be applied in most of the practical applications due to large consumption of computing resources.

In following, a decimation in frequency (DIF) algorithm with the base of 2 is taken as an example to explain how significantly the DFT computing is reduced with the algorithm. When an input vector x with N-points data is power of 2, the output vector with N-points data of the above-mentioned formula 1 can be resolved into even and odd portions, in which the points of even frequencies can be expressed in following formula 2, while the points of odd frequencies can be expressed in following formula 3:

$$\begin{matrix}\begin{matrix}X ( 2 m ) = {\sum }_{n = 0}^{\frac{N}{2} - 1} [ x ( n ) + x ( n + \frac{N}{2} ) ] * {W}_{\frac{N}{2}}^{nm} \\ = {DFT}_{\frac{N}{2}} [ x ( n ) + x ( n + \frac{N}{2} ) ] ,\end{matrix} \\ and & ( 2 ) \\ \begin{matrix}X ( 2 m + 1 ) = {\sum }_{n = 0}^{\frac{N}{2} - 1} [ {W}_{N}^{n} * ( x ( n ) - x ( n + \frac{N}{2} ) ) ] * {W}_{\frac{N}{2}}^{nm} \\ = {DFT}_{\frac{N}{2}} [ ( x ( n ) - x ( n + \frac{N}{2} ) ) * {W}_{N}^{n} ] .\end{matrix} & ( 3 )\end{matrix}$$

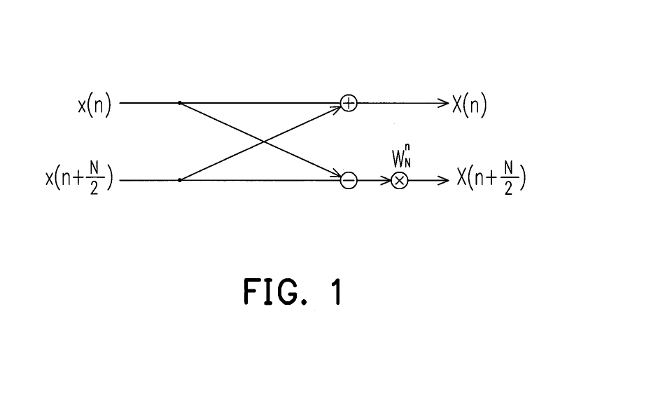

The above-mentioned formulas 2 and 3 indicates the even index values and the odd index values of the frequency output X(k) can be obtained by using data of a less N/2 points through a DFT operation. As shown by FIG. 1, which is a schematic diagram showing an FFT's butterfly operation of “DIF with the base of 2”, in which the twiddle factors are expressed by formula 4:

$${W}_{N}^{n} = {e}^{\frac{- j 2 π kn}{N}} , \\ n = 0 , 1 , 2 , … , ( \frac{N}{2} - 1 ) . \qquad ( 4 )$$

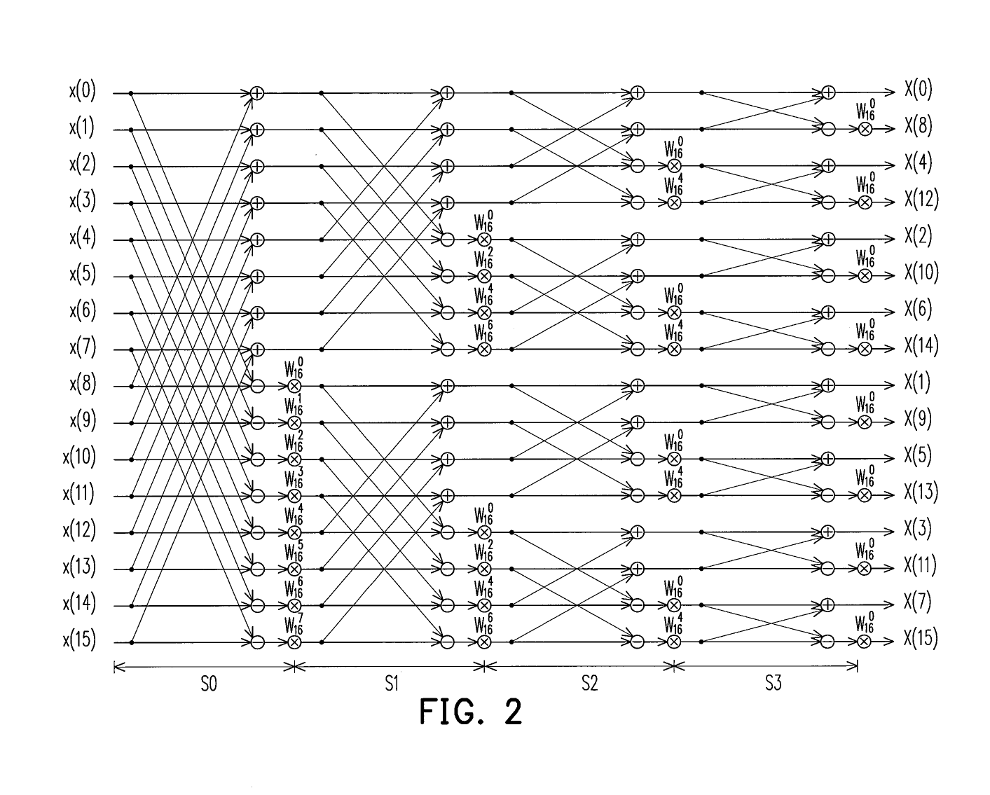

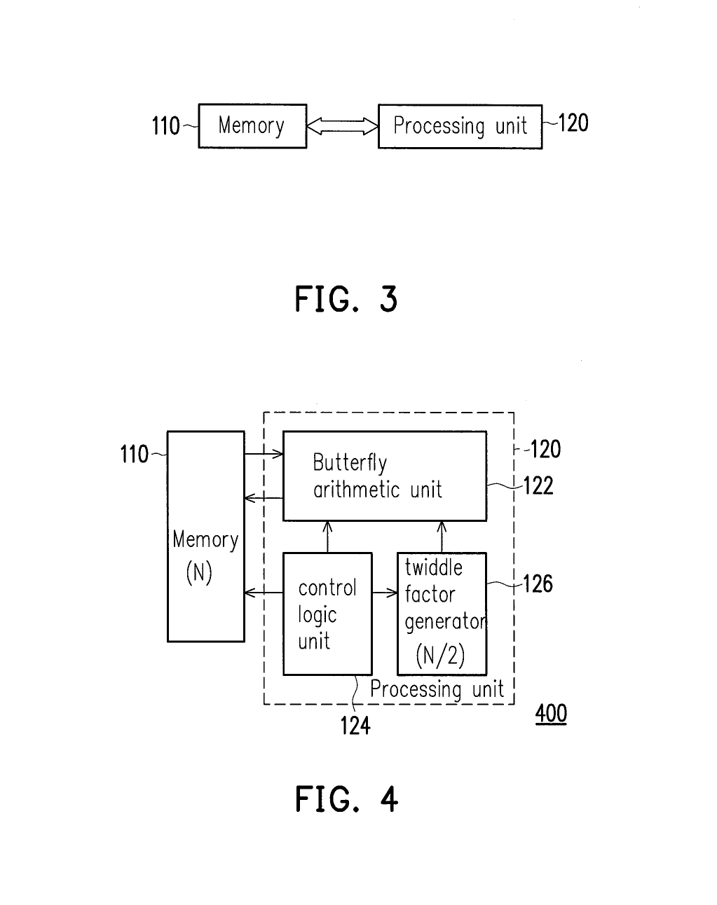

FIG. 2 is a signal processing flowchart illustrating a 16-points FFT and FIG. 3 is a diagram showing a general architecture of a single processing unit. Referring to FIGS. 2 and 3, original data which an FFT operation is to be performed on are placed in the left of the flowchart (taking 16 points as an example), while target data which are obtained after finishing the FFT operation are placed in the right of the flowchart. In FIG. 2, “⊕” represents performing complex adding, “ [symbol] ” represents performing complex subtraction, and “ [symbol] ” represents performing complex multiplication. The original data required by the FFT operation need to be stored in a memory 110 in advance. During the first step S0, a processing unit 120 sequentially reads a plurality of data pairs [x(0), x(8)], [x(1), x(9)], [x(2), x(10)], . . . , [x(7), x(15)] to respectively perform a butterfly operation (containing a complex adding operation, a complex subtraction operation and a complex multiplication operation) and then writes back the operation result of each time to the memory 110. Once the first step S0 is finished, the processing unit 120 starts performing second step S1, where the processing unit 120 sequentially read the operation result of the first step S0, the data pairs [x(0), x(4)], [x(3), x(7)], [x(8), x(12)], . . . , [x(11), x(15)], to respectively perform a butterfly operation and then writes back the operation result of each time to the memory 110. Analogy to the rest, steps S2 and S3 are finished. Thus, the 16-ponts FFT operation can be finished by using a single processing unit. The same method can be analogy to FFT operation with any length.

The computational complexity required by directly performing DFT is N². Thus, in a digital signal processing system of DIF FFT, the operation result can be quickly obtained and at the time, the original computational complexity is changed from N² times of complex multiplications to

$$\frac{N}{2} * {log}_{2} ( N ) .$$

Along with more and more important roles the FFT plays, many researches of implementing FFT provided implementation methods to achieve faster and more accurate DFT results. However, regardless of what implementation methods, the required spaces of memory and twiddle factor generator are always a factor that must be considered in assessing the implementation process. FIG. 4 is a general architecture diagram showing a butterfly operation-based digital signal processing apparatus. A digital signal processing apparatus 400 includes a memory 110 and a processing unit 120, in which the processing unit 120 includes a butterfly arithmetic unit 122, a control logic unit 124 and a twiddle factor generator 126. For N-points FFT operation, the memory 110 has N-points data stored therein and the twiddle factor generator 126 needs to store N/2-points twiddle factors. For example, for the memory 110 having stored 131072-points data, the twiddle factor generator 126 needs to store 65536-points twiddle factors. It can be seen when the sampling points to be operated by FFT are increased, the sizes of the memory 110 and the twiddle factor generator 126 are also significantly increased, and meanwhile, the energy consumption of the twiddle factor generator 126 is increased as well.

In order to solve the above-mentioned problem, an embodiment of the disclosure provides an operation architecture. Referring to formula 4, for any number k and

$$0 \leq k \leq ( \frac{N}{2} - 1 ) ,$$

the twiddle factors can be rewritten as formula 5 according to exponent characteristic.

$$\begin{matrix}\begin{matrix}{W}_{N}^{k} = {e}^{\frac{- j 2 π k}{N}} \\ = {e}^{\frac{- j 2 π ( k - 1 )}{N}} * {e}^{\frac{- j 2 π}{N}} \\ = {e}^{\frac{- j2π}{N}} * {e}^{\frac{- j2π}{N}} * … * {e}^{\frac{- j2π}{N}} \\ = {\prod }_{d = 0}^{k - 1} {e}^{\frac{- j2π}{N}} \\ = {\prod }_{d = 0}^{k - 1} ( cos ( \frac{2 π}{N} ) + j sin ( \frac{2 π}{N} ) ) .\end{matrix} & ( 5 ) \\ 0 \leq k \leq ( \frac{N}{2} - 1 ) . & ( 6 )\end{matrix}$$

If the required address bit number Q corresponding to N/2 points meets:

$$Q = {log}_{2} ( \frac{N}{2} ) ,$$

then, any number k can be expressed by formula 7 through binary-format Q bit.

$$k = {\sum }_{i = 0}^{Q - 1} {a}_{i} * {2}^{i} = {\sum }_{i = 0}^{R - 1} {a}_{i} * {2}^{i} + {2}^{R} {\sum }_{j = 0}^{Q - R - 1} {a}_{R + j} * {2}^{j} , \qquad ( 7 )$$

wherein aᵢ,aⱼε{1,0}, R is an integer and 0≦R≦(Q−1).

Substituting formula 7 for the item “k” in formula 6, following formulas 8 and 9 are obtained.

$$\begin{matrix}\begin{matrix}{W}_{N}^{k} = {e}^{\frac{- j 2 π * ( {\sum }_{i = 0}^{R - 1} {a}_{i} * {2}^{i} + {2}^{R} {\sum }_{j = 0}^{Q - R - 1} {a}_{R - j} * {2}^{j} )}{N}} \\ = {e}^{\frac{- j2π * {\sum }_{i = 0}^{R - 1} {a}_{i} * {2}^{i}}{N}} * {e}^{\frac{- j2π * {2}^{R} * {\sum }_{j = 0}^{Q - R - 1} {a}_{R - j} * {2}^{j}}{N}} \\ = {e}^{\frac{- j 2 π {A}_{r}}{N}} * ( {e}^{\frac{- j2π * {2}^{R} * {A}_{{r}^{′}}}{N}} ) .\end{matrix} & ( 8 ) \\ {W}_{N}^{k} = {W}_{N}^{{A}_{r}} * {W}_{N}^{{2}^{R} * {A}_{{r}^{′}}} , wherein {A}_{r} = {\sum }_{i - 0}^{R - 1} {a}_{i} * {2}^{i} {A}_{{r}^{′}} = {\sum }_{j = 0}^{Q - R - 1} {a}_{j + R} * {2}^{j} . & ( 9 )\end{matrix}$$

Any given binary number k can be resolved into two portions according to formulas 7, 8 and 9. The first portion contains R bits of least significant bit (LSB) and the second portion contains “Q−R” bits of most significant bit (MSB). At the time, the corresponding twiddle factor W_{N}^{k} can be obtained by performing a complex multiplication operation on two sub-twiddle factors W_{N}^{A}^{ᵣ} and W_{N}²^{^{R}}^{*A}^{_{r′}}. Since 0≦Aᵣ≦(2^{R}−1) and 0≦A_{r′}≧(2^{Q-R}−1), the required memory space for storing the point numbers of W_{N}^{A}^{ᵣ} and W_{N}²^{^{R}}^{*A}^{_{r′}} can be reduced to the space of “2^{R}+2^{Q-R}” points from the space of original 2^{Q} points.

In order to obtain the optimal R value, a differential operation needs to be performed as the following formula 10.

$$\frac{d ( {2}^{Q - R} + {2}^{R} )}{d R} = 0. \qquad ( 10 )$$

From formula 10, when

$$R = \frac{Q}{2} ,$$

the point number of the obtained sub-twiddle factors is the minimal value. Since R is an integer, so it can make:

$$R = floor ( \frac{Q}{2} ) , \qquad ( 11 )$$

wherein floor( ) is a mathematic function rounded down to its nearest integer. In another embodiment of the disclosure, it can also make

$$R = ceiling ( \frac{Q}{2} ) ,$$

and ceiling( ) herein is a mathematic function rounded up to its nearest integer.

According to formula 11, if the FFT data Q of N points meets

$$Q = {log}_{2} ( \frac{N}{2} ) ,$$

the required point numbers produced by the twiddle factors can be reduced to

$$“ {2}^{floor ( \frac{Q}{2} )} + {2}^{Q \text{-} floor ( \frac{Q}{2} )} ”$$

points from the original 2^{Q} points. For example, for the FFT data of 8192 points, the original point number of twiddle factors is 4096, but by means of the formulas of resolving the twiddle factors into two kinds of sub-twiddle factors, the required point number is

$${2}^{floor ( \frac{12}{2} )} + {2}^{12 \text{-} floor ( \frac{12}{2} )} = {2}^{6} + {2}^{6} = 128.$$

It can be seen the point number of all the twiddle factors are decreased to 32 times less than the original one (4096/128=32), which largely reduces the required memory space.

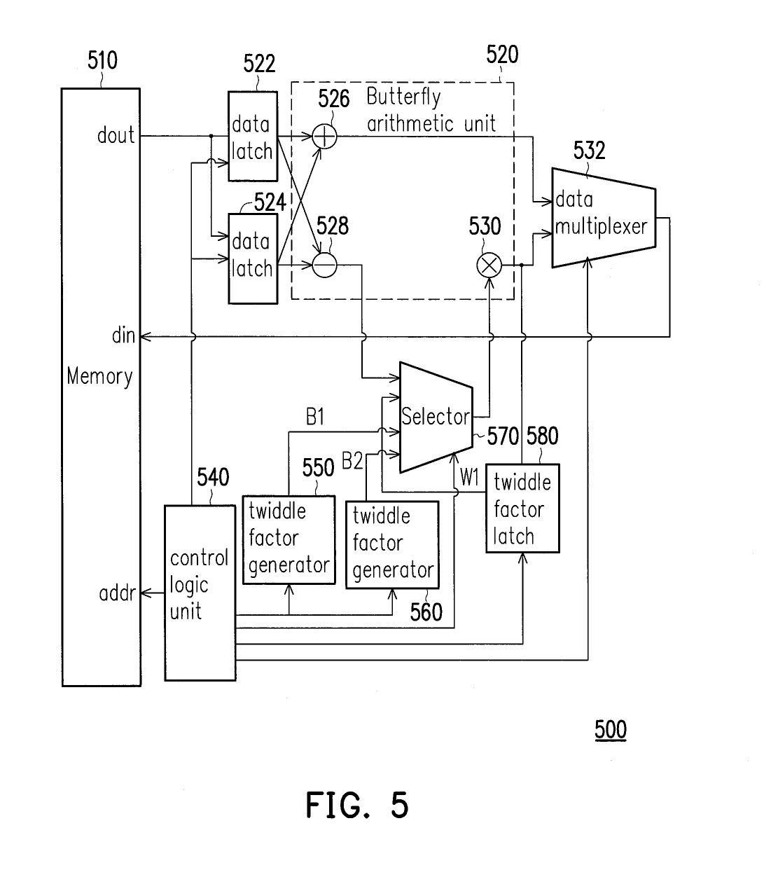

FIG. 5 is a schematic diagram of a digital signal processing apparatus 500 according to an embodiment of the disclosure, which is based on the operation architecture of resolving the twiddle factors into the sub-twiddle factors. Referring to FIG. 5, a digital signal processing apparatus 500 includes a memory 510, a butterfly arithmetic unit 520, a control logic unit 540, a selector 570, two twiddle factor generators 550 and 560 and a twiddle factor latch 580.

It should be noted that if the memory 510 stores N-points data and

$$Q = {log}_{2} ( \frac{N}{2} ) ,$$

according to formula 7-formula 9, the twiddle factor generator 550 can provide the following sub-twiddle factor B1 for the R bits of LSB, in which the sub-twiddle factor

$$B 1 = {e}^{\frac{- j2π * {A}_{r}}{N}} ;$$

the twiddle factor generator 560 can provide the following sub-twiddle factor B2 for the “Q-R” bits of MSB, in which the sub-twiddle factor

$$B 2 = {e}^{\frac{- j 2 π * {2}^{R} * {A}_{{r}^{′}}}{N}} ,$$

wherein k=0, 1,

$$2 , … , ( \frac{N}{2} - 1 ) , \qquad {A}_{r} = {\sum }_{i = 0}^{R - 1} {a}_{i} * {2}^{i} , \qquad {A}_{{r}^{′}} = {\sum }_{j = 0}^{Q - R - 1} {a}_{j + R} * {2}^{j} ,$$

aᵢ and aⱼε{1, 0}, R is an integer and 0≦R≦(Q−1).

In addition, according to formula 11, if the memory 510 stores N-points data and

$$Q = {log}_{2} ( \frac{N}{2} ) ,$$

the point number of the sub-twiddle factor B1 which the memory space of the twiddle factor generator 550 can store in advance is

$${2}^{floor ( \frac{Q}{2} )}$$

and the sub-twiddle factor

$$B 1 = {e}^{\frac{- j 2 π * {\sum }_{i = 0}^{floor ( \frac{Q}{2} ) - 1} {a}_{i} * {2}^{i}}{N}} ,$$

the memory space of the twiddle factor generator 560 can store in advance is

$${2}^{Q - floor ( \frac{Q}{2} )}$$

and the sub-twiddle factor

$$B 2 = {e}^{\frac{- j2π * {\sum }_{i = 0}^{Q - floor ( \frac{Q}{2} ) - 1} {a}_{i + floor ( \frac{Q}{2} )} * {2}^{i}}{N}} ,$$

in which floor( ) is a mathematic function rounded down to its nearest integer.

The memory 510 has a data input terminal din, a data output terminal dout and a address terminal addr. The control logic unit 540 is electrically connected to the address terminal addr, and the butterfly arithmetic unit 520 is electrically connected to the data output terminal dout, the data input terminal din and the control logic unit 540. The selector 570 is electrically connected to the butterfly arithmetic unit 520 and the control logic unit 540. The two twiddle factor generators 550 and 560 are electrically connected to the control logic unit 540 and the selector 570. The twiddle factor latch 580 is electrically connected to the control logic unit 540 and the butterfly arithmetic unit 520.

By means of the control of the control logic unit 540, after performing a complex multiplication operation on the sub-twiddle factors B1 and B2 by the butterfly arithmetic unit 520, the twiddle factor latch 580 can latch the weight value W1 (twiddle factor) of the sub-twiddle factors B1 and B2 after the complex multiplication operation. And the general formula W_{N}^{k} of the weight value W1 can be expressed as

$${e}^{\frac{- j2π * {A}_{r}}{N}} * {e}^{\frac{- j2π * {2}^{R} * {A}_{{r}^{′}}}{N}}$$

according to formula 9.

The digital signal processing apparatus 500 further includes a data latch 522, a data latch 524 and a data multiplexer 532. The butterfly arithmetic unit 520 can include a complex multiplier 530, a complex adder 526 and a complex subtractor 528. The complex multiplier 530 is electrically connected to the selector 570 and the twiddle factor latch 580; the data multiplexer 532 is electrically connected to the complex adder 526, the complex multiplier 530, the control logic unit 540 and the data input terminal din; the complex adder 526 is electrically connected to the data latch 522 and the data latch 524; the complex subtractor 528 is electrically connected to the data latch 522, the data latch 524 and the selector 570. The selector 570 can be, for example, a multiplication input selector, which outputs the input signal to the complex multiplier 530 for performing the successive operation according to the control signal. The data latch 522 and the data latch 524 are electrically connected to the data output terminal dout, the control logic unit 540 and the butterfly arithmetic unit 520. The data latch 522 and/or the data latch 524 read data from the memory 510 through the data output terminal dout, followed by outputting the read data to the complex adder 526 and/or the complex subtractor 528 for operations.

In a modified embodiment of the disclosure, the data latch 522 and/or data latch 524 can be saved without employing them. For example, two data output terminals dout are employed and, for example, two memory access addresses are produced by a control logic unit (for example, the control logic unit 540 or an additionally employed control logic unit). At the time, the data in the corresponding position of the memory 510 is read and then output to the complex adder 526 and/or the complex subtractor 528 through the data output terminals dout.

The control logic unit 540 is used to perform the following related controls: (a) producing the access addresses of the memory 510 so as to read data from the corresponding position of the memory 510 and/or write data back to the corresponding position of the memory 510; (b) making the twiddle factor generators 550 and 560 respectively produce the sub-twiddle factors B1 and B2 according to the access addresses; (c) controlling two input pairs in the selector 570 so as to perform a complex multiplication operation on one of the two input pairs by the complex multiplier 530, for example, the selector 570 has two input pairs, in which the first input pairs are sub-twiddle factors B1 and B2, on which a complex multiplication operation is performed so as to obtain the weight value W1, while the second input pairs are the operation result of the complex subtractor 528 and the weight value W1, on which a complex multiplication operation is performed; (d) performing a latching control on the weight value W1 of the twiddle factor latch 580; (e) writing the operation result of the data multiplexer 532 back to the memory 510; (f) performing a latching control on the data of the memory 510.

It should be noted that the same complex multiplier 530 can be used both for operation to obtain the weight value W1 or for perform a complex multiplication operation on the operation result of the complex subtractor 528 and the weight value W1. Due to the circuit complexity of the complex multiplier 530, by sharing one complex multiplier 530 in the embodiment, it can avoid to increase the huge circuit area of the digital signal processing apparatus 500.

In addition, the butterfly arithmetic unit 520 in the digital signal processing apparatus 500 can, in association with the data latches 522 and 524, perform the procedure flow of FIG. 2 so as to perform a butterfly operation with the base of 2. The data latches 522 and 524 read a plurality of data pairs [x(0), x(8)], [x(1), x(9)], [x(2), x(10)], . . . , [x(7), x(15)] from the memory 510 to respectively perform a butterfly operation (containing a complex adding operation, a complex subtraction operation and a complex multiplication operation), and the data multiplexer 532 writes the operation results back to the corresponding positions in the memory 510. Once the first step S0 is finished, the digital signal processing apparatus 500 starts to perform the second step S1, i.e., sequentially reading the operation result of the first step S0 of data pairs [x(0), x(4)], . . . , [x(3), x(7)], [x(8), x(12)], . . . , [x(11), x(15)] from the memory 510 so as to respectively perform a butterfly operation and to write the operation result each time back to the memory 510, and it is analogy to the rest to continue finishing step S2 and step S3. Any people skilled in the art can follow the above-mentioned instruction so as to deduct/infer the same method to the FFT operation with any length, which is omitted to describe.

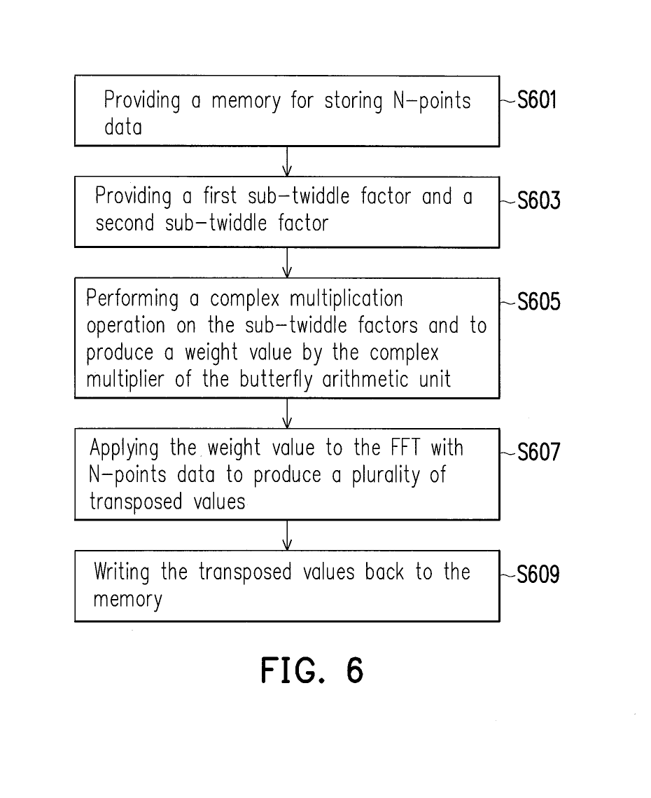

Based on the content disclosed by the above-mentioned embodiment, a general digital signal processing method can be summarised. FIG. 6 is a flowchart showing a signal processing method according to an embodiment of the disclosure. Referring to FIGS. 5 and 6, the digital signal processing method of the embodiment includes following steps.

As shown by step S601, a memory 510 for storing N-points data is provided.

As shown by step S603, a (first) sub-twiddle factor B1 and a (second) sub-twiddle factor B2 are provided. If

$$Q = {log}_{2} ( \frac{N}{2} ) ,$$

the memory space of the twiddle factor generator 550 can store point number of

$${2}^{floor ( \frac{Q}{2} )}$$

of the sub-twiddle factor B1 in advance. At the time, the sub-twiddle factor

$$B 1 = {e}^{\frac{- j2π * {\sum }_{i = 0}^{floor ( \frac{Q}{2} ) - 1} {a}_{i} * {2}^{i}}{N}} ,$$

while the memory space of the twiddle factor generator 560 can store point number of

$${2}^{Q - floor ( \frac{Q}{2} )}$$

of the sub-twiddle factor B2 in advance. At the time, the sub-twiddle factor

$$B 2 = {e}^{\frac{- j 2 π * {\sum }_{i = 0}^{Q - floor ( \frac{Q}{2} ) - 1} {a}_{i + floor ( \frac{Q}{2} )} * {2}^{i}}{N}} ,$$

in which floor( ) is a mathematic function rounded down to its nearest integer.

As shown by step S605, the complex multiplier 530 of the butterfly arithmetic unit 520 performs a complex multiplication operation on the sub-twiddle factors B1 and B2 to produce a weight value W1.

As shown by step S607, the weight value W1 is applied to the FFT with N-points data to produce a plurality of transposed values (i.e., the operation result of the butterfly operation each time).

As shown by step S609, the transposed values are written back to the memory 510.

In summary, the digital signal processing apparatus 500 of the embodiment can dramatically reduce the point numbers of the all twiddle factors, and the twiddle factors to be obtained can be got by performing a complex multiplication operation on the outputs of the twiddle factor generators 550 and 560. Apparently, since the twiddle factors are disassembled into two kinds of twiddle factors through the exponent characteristic in the embodiment and then the butterfly arithmetic unit in the FFT architecture is used to compute the twiddle factors without increasing the huge additional circuit, so that the disclosure will not largely increase the circuit area. On the other hand, the disclosure can effectively reduce the storing amount for the required number of the twiddle factors in the butterfly operation.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A digital signal processing apparatus, comprising:
a memory, having a data output terminal, a data input terminal and an data address terminal;
a control logic unit, electrically connected to the data address terminal;
a butterfly arithmetic unit, electrically connected to the data output terminal, the data input terminal and the control logic unit;
a selector, electrically connected to the butterfly arithmetic unit and the control logic unit;
a first twiddle factor generator and a second twiddle factor generator, electrically connected to the control logic unit and the selector, wherein the first twiddle factor generator and the second twiddle factor generator respectively provide a first sub-twiddle factor and a second sub-twiddle factor; and
a twiddle factor latch, electrically connected to the control logic unit and the butterfly arithmetic unit, wherein the twiddle factor latch is for latching a weight value of the first sub-twiddle factor and the second sub-twiddle factor after a complex multiplication operation performed by the butterfly arithmetic unit.

2. The digital signal processing apparatus as claimed in claim 1, further comprising:
a first data latch and a second data latch, electrically connected to the data output terminal, the control logic unit and the butterfly arithmetic unit; and
a data multiplexer, electrically connected to the butterfly arithmetic unit, the twiddle factor generator and the control logic unit, wherein the data multiplexer writes back operation result to a corresponding position in the memory according to the control of the control logic unit.

3. The digital signal processing apparatus as claimed in claim 2, wherein the butterfly arithmetic unit comprises:
a complex multiplier, electrically connected to the selector, the twiddle factor latch and the data multiplexer, wherein the complex multiplier performs a complex multiplication operation and produces the weight value;
a complex adder, electrically connected to the first data latch, the second data latch and the data multiplexer; and
a complex subtractor, electrically connected to the first data latch, the second data latch and the selector.

4. The digital signal processing apparatus as claimed in claim 1, wherein the butterfly arithmetic unit performs a butterfly operation with the base of 2.

5. The digital signal processing apparatus as claimed in claim 1, wherein if the memory stores N-points data and required address bit number Q corresponding to N/2-points meets
$$Q = {log}_{2} ( \frac{N}{2} ) ,$$
the first sub-twiddle factor and the second sub-twiddle factor are respectively
$${e}^{\frac{- j 2 π * {A}_{r}}{N}} and {e}^{\frac{- j2π * {2}^{R} * {A}_{{r}^{′}}}{N}} ,$$
the weight value W_{N}^{k} is
$${e}^{\frac{- j2π * {A}_{r}}{N}} * {e}^{\frac{- j2π * {2}^{R} * {A}_{{r}^{′}}}{N}} ,$$
wherein k=0, 1, 2, . . . ,
$$( \frac{N}{2} - 1 ) , {A}_{r} = {\sum }_{i = 0}^{R - 1} {a}_{i} * {2}^{i} , {A}_{{r}^{′}} = {\sum }_{j = 0}^{Q - R - 1} {a}_{j + R} * {2}^{j} ,$$
aᵢ and aⱼε{1, 0}, R is an integer and 0≦R≦(Q−1).

6. The digital signal processing apparatus as claimed in claim 1, wherein if the memory stores N-points data and required address bit number Q corresponding to N/2-points meets
$$Q = {log}_{2} ( \frac{N}{2} ) ,$$
memory spaces of the first twiddle factor generator and the second twiddle factor generator respectively store first sub-twiddle factors of
$${2}^{floor ( \frac{Q}{2} )}$$
pieces and second sub-twiddle factors of
$${2}^{Q - floor ( \frac{Q}{2} )}$$
pieces, or respectively store first sub-twiddle factors of
$${2}^{ceiling ( \frac{Q}{2} )}$$
pieces and second sub-twiddle factors of
$${2}^{Q - ceiling ( \frac{Q}{2} )}$$
pieces, wherein floor( ) is a mathematic function rounded down to its nearest integer and ceiling( ) is a mathematic function rounded up to its nearest integer.

7. The digital signal processing apparatus as claimed in claim 1, further comprising:
a data multiplexer, electrically connected to the butterfly arithmetic unit, the twiddle factor latch and the control logic unit, wherein the data multiplexer writes back operation result to a corresponding position in the memory according to the control of the control logic unit.

8. The digital signal processing apparatus as claimed in claim 7, wherein the butterfly arithmetic unit comprises:
a complex multiplier, electrically connected to the selector, the twiddle factor latch and the data multiplexer;
a complex adder, electrically connected to first data output terminal of the memory and the data multiplexer; and
a complex subtractor, electrically connected to second data output terminal of the memory and the selector.

9. A digital signal processing method, comprising:
providing a memory for storing N-points data;
providing a first sub-twiddle factor and a second sub-twiddle factor;
performing a complex multiplication operation on the first sub-twiddle factor and a second sub-twiddle factor by a complex multiplier of a butterfly arithmetic unit so as to produce a weight value;
applying the weight value to fast Fourier transform with N-points data so as to produce a plurality of transposed values; and
writing back the transposed values to the memory.

10. The digital signal processing method as claimed in claim 9, wherein the butterfly arithmetic unit performs a butterfly operation with the base of 2.

11. The digital signal processing method as claimed in claim 9, wherein if the memory stores N-points data and
$$Q = {log}_{2} ( \frac{N}{2} ) ,$$
the first sub-twiddle factor and the second sub-twiddle factor are respectively
$${e}^{\frac{- j 2 π * {A}_{r}}{N}} and {e}^{\frac{- j 2 π * {2}^{R} * {A}_{{r}^{′}}}{N}} ,$$
the weight value W_{N}^{k} is
$${e}^{\frac{- j 2 π * {A}_{r}}{N}} * {e}^{\frac{- j 2 π * {2}^{R} * {A}_{{r}^{′}}}{N}} ,$$
wherein k=0, 1, 2, . . . ,
$$( \frac{N}{2} - 1 ) ,$$
$${A}_{r} = {\sum }_{i = 0}^{R - 1} {a}_{i} * {2}^{i} , {A}_{{r}^{′}} = {\sum }_{j = 0}^{Q - R - 1} {a}_{j + R} * {2}^{j} ,$$
aᵢ and aⱼε{1, 0}, R is an integer and 0≦R≦(Q−1).

12. The digital signal processing method as claimed in claim 9, further comprising providing a first twiddle factor generator and a second twiddle factor generator to respectively provide a first sub-twiddle factor and a second sub-twiddle factor, wherein if the memory stores N-points data and
$$Q = {log}_{2} ( \frac{N}{2} ) ,$$
memory spaces of the first twiddle factor generator and the second twiddle factor generator respectively store first sub-twiddle factors of
$${2}^{floor ( \frac{Q}{2} )}$$
pieces and second sub-twiddle factors of
$${2}^{Q - floor ( \frac{Q}{2} )}$$
pieces, or respectively store first sub-twiddle factors of
$${2}^{ceiling ( \frac{Q}{2} )}$$
pieces and second sub-twiddle factors of
$${2}^{Q - ceiling ( \frac{Q}{2} )}$$
pieces, wherein floor( ) is a mathematic function rounded down to its nearest integer and ceiling( ) is a mathematic function rounded up to its nearest integer.
